(19) United States
(12) Patent Application Publication
(10) Pub. No.: US 2023/0166724 A1
(43) Pub. Date: Jun. 1, 2023

(54) SUPPLEMENTAL BATTERY POWER FOR MOVING AN ELECTRIC VEHICLE

(71) Applicant: Rivian IP Holdings, LLC, Irvine, CA (US)

(72) Inventors: Baojin Wang, Saline, MI (US); Chen Yin, Irvine, CA (US); Jing Hong, Trabuco Canyon, CA (US)

(21) Appl. No.: 17/536,977

(22) Filed: Nov. 29, 2021

(51) Int. Cl. B60W 30/06; B60L 50/51; H01M 10/42; B60L 58/24; B60L 53/22; G05D 1/00

(52) U.S. Cl. CPC B60W 30/06; B60L 50/51; H01M 10/425; B60L 58/24; B60L 53/22; G05D 1/0061; B60L 2210/10; H01M 2010/4271; B60L 2240/527

(57) ABSTRACT

Systems and methods for driving a motor of an electric vehicle using a secondary battery are disclosed. A vehicle may include a first battery module having a first operating voltage configured to drive the motor, a second battery module having a second operating voltage lower than the first operating voltage, and a bidirectional converter. The controller may be configured to detect a thermal parameter exceeding a predetermined magnitude while the vehicle is in a parked position, and in response modify a supply voltage of the first battery module, and thereafter to drive the electric motor using electrical power supplied by the second battery module, thereby moving the vehicle from the parked position.

### INTRODUCTION

The present disclosure is directed to a battery electric vehicle, and more particularly towards a system for moving the battery electric vehicle from a parked position.

### SUMMARY

At least some example illustrations herein are directed to a battery management system, e.g., for an electric motor. The system may include a controller in communication with a first battery module having a first operating voltage configured to drive the electric motor, the controller also being in communication with a second battery module having a second operating voltage lower than the first operating voltage, and a bidirectional converter. The bidirectional converter may be configured to modify a first input voltage to the second battery module such that the second battery module operates at the second operating voltage lower than the first operating voltage.

At least some example illustrations are directed to a propulsion system for a vehicle, comprising an electric motor and a first battery module comprising a first operating voltage configured to drive the electric motor. The propulsion system may further include a battery management system for the electric motor, comprising a controller in communication with the first battery module, the controller in communication with a second battery module comprising a second operating voltage lower than the first operating voltage. The battery management system may further include a bidirectional converter configured to modify a first input voltage to the second battery module such that the second battery module operates at the second operating voltage lower than the first operating voltage.

In at least some example illustrations, a method of moving a parked vehicle having an electric motor configured to drive at least one ground-engaging wheel includes detecting, in a first battery module having a first operating voltage, a thermal parameter exceeding a predetermined magnitude. The first battery module may be configured to drive the electric motor to provide motive force to the vehicle. The method may further include, in response to the detection of the thermal parameter exceeding the predetermined magnitude, modifying a supply voltage of the first battery module. The method may also include, after modifying the supply voltage of the first battery module, driving the electric motor using a second battery module having a second operating voltage lower than the first operating voltage, thereby moving the vehicle.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1A shows a schematic view of an illustrative vehicle having a traction battery, a battery management system for the traction battery, and a secondary battery, with the traction battery in an electrically isolated state, in accordance with some embodiments of the present disclosure;

FIG. 1B shows a schematic view of the vehicle of FIG. 1A with the traction battery electrically connected to bus rails of the vehicle, e.g., for supplying power or being charged, in accordance with some embodiments of the present disclosure;

FIG. 1C shows a schematic view of the vehicle of FIGS. 1A and 1B with the traction battery being charged via a DC power supply, in accordance with some embodiments of the present disclosure;

FIG. 2A shows a plan view of an illustrative vehicle that is parked in a parking lot, in accordance with some embodiments of the present disclosure;

FIG. 2B shows a plan view of an illustrative vehicle that is parked in a garage, in accordance with some embodiments of the present disclosure; and

FIG. 3 shows a flowchart of an illustrative process for moving a vehicle from a parked position by supplying power from a secondary battery to a vehicle motor, in accordance with some embodiments of the present disclosure.

### DETAILED DESCRIPTION

Battery electric vehicles may employ relatively large capacity, high-voltage batteries for driving one or more electric motors to provide propulsion for the vehicle. Given the capacity of these battery modules and heavy-duty cycles, various features have been developed to control battery temperature and pressure in an effort to prevent adverse operating conditions for the battery. Merely as one example, battery modules are typically provided with vents or other passive measures for relieving temperature or pressure variations within the battery module.

Generally, it would be desirable to disconnect the traction battery upon detection of more extreme thermal conditions, to the extent isolating the battery electrically may help to prevent an electrical short or other abnormality in an electrical circuit with the battery from causing further degradation or exacerbating the abnormal condition(s) in the battery. However, this also necessarily immobilizes the vehicle, preventing moving the vehicle, e.g., away from other vehicles or property, out of a garage, etc. Thus, the immobilized vehicle can cause nearby property damage to the extent it cannot be moved away from property and a thermal condition continues to escalate.

Accordingly, example approaches herein generally provide a battery management system configured to modify a supply voltage of a traction battery, while providing power to vehicle motor(s) to facilitate moving the vehicle at least a relatively short distance. In examples herein, a supply voltage of a traction battery may be modified by reducing voltage available from the traction battery or in communication with electrical loads of the traction battery. In some examples, the traction battery may be disconnected, or may be electrically isolated. In some examples, a power converter may draw power from a relatively lower-voltage secondary battery while the supply voltage of the traction battery has been modified, and convert the power to a higher voltage to supply power sufficient to drive the main motor(s) for at least a relatively short time or distance. Moreover, in some examples the battery management system may allow the vehicle to be autonomously or automatically driven upon detection of a thermal event while the vehicle is parked or not occupied.

Example vehicles may employ an early-stage detection of potential thermal conditions of a battery and may respond with various active measures to reduce damage to property or potential harm to others. Merely as examples, “smart” home connections may be employed by the vehicle to provide alerts regarding a thermal condition of a battery, actuate a garage door opener, or take other actions to clear a safe path for the vehicle to facilitate autonomously driving or moving the vehicle at least a short distance from the parked/stored location. By powering the main motor(s) with a secondary battery, the traction battery of the vehicle may remain disconnected to reduce the likelihood that any factors causing the thermal condition of the traction battery will continue. The secondary battery may allow the vehicle to move itself away from other vehicles in a parking lot, out of a customer garage, or the like, thereby reducing the likelihood of a thermal runaway event propagating from the vehicle to adjacent property, should the thermal condition continue to escalate.

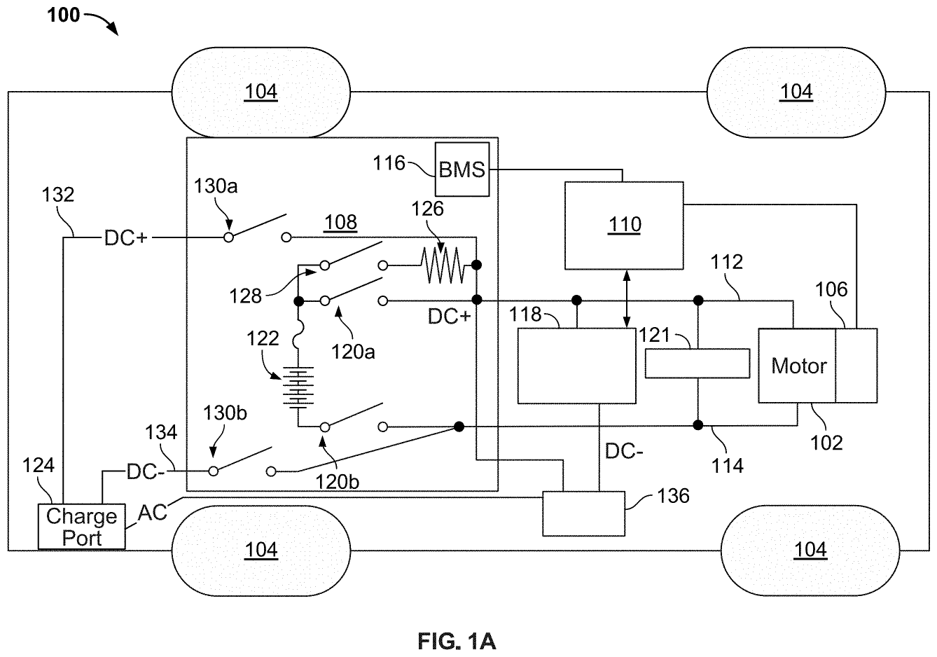

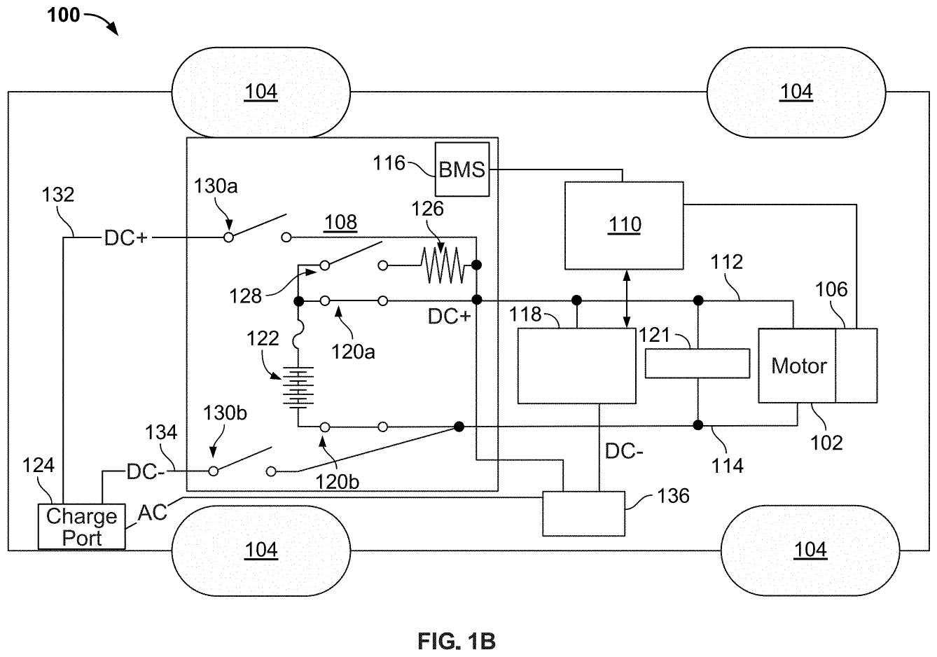

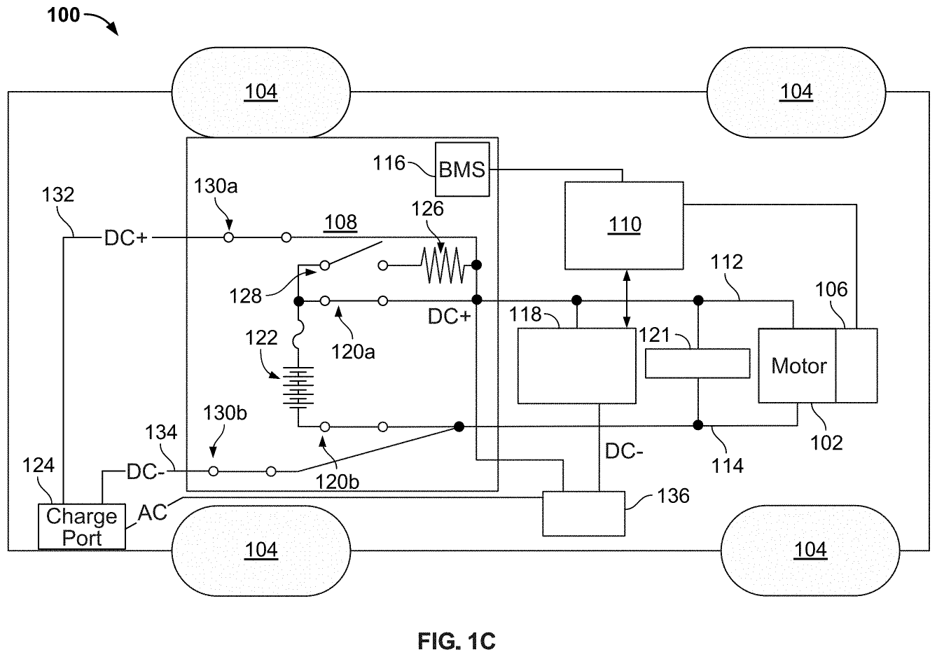

Referring now to FIGS. 1A-1C, an illustrative vehicle 100 is shown having multiple batteries for supplying electrical power to one or more electric motors 102, in accordance with some embodiments of the present disclosure. While a single motor 102 is illustrated schematically, the vehicle 100 includes four ground-engaging wheels 104 and may have multiple motors, e.g., one motor 102 for each wheel 104. Each motor(s) 102 may include an electric motor, a gearbox (e.g., a reduction gearset or pulley set), a shaft coupling (e.g., to one of wheels 104), auxiliary systems (e.g., a lubricating oil system, a cooling system, a power electronics system), any other suitable components, or any combination thereof to provide torque to one or more of the wheels 104.

The motor(s) 102 may be coupled to a motor control system 106. The motor control system 106 may be configured to generate commands for each of the motor(s) 102 to effect driving of the vehicle 100, e.g., by way of torque commands. In some embodiments where multiple motors 102 are provided, motor control system 106 generates control signals for each of the motors 102. The control signals may include messages, current values, pulse width modulation (PWM) values, any other suitable values, any other information indicative of a desired operation, or any combination thereof. The motor control system 106 may also include a speed controller (e.g., a proportional-integral-derivative (PID) feedback controller), a torque controller, a current controller (e.g., per motor phase of each motor), a position controller, any other suitable controllers, or any combination thereof. Moreover, motor control system 106 may include adaptive cruise control, semi-autonomous control, or fully autonomous control capabilities with respect to the vehicle 100 and components thereof, e.g., the motor(s) 102, vehicle steering, etc. Alternatively, the vehicle 100 may have one or more vehicle controller(s) (e.g., receiving low-voltage power from the battery 110 and/or converter 118) separate from the motor controller 102, with the vehicle controller(s) configured to facilitate autonomous or semi-autonomous driving or control of the vehicle 100.

The vehicle 100 may include a first battery module 108, which may be a traction battery for driving the motor(s) 102. The vehicle 100 may also have a second battery 110 for supplying relatively lower-voltage power to other modules or electrical components of the vehicle 100. For example, as will be discussed further below, the second battery 110 may be used to supply power to various controllers of the vehicle 100, e.g., motor controller 106, an air conditioning controller, display controllers, etc. Moreover, as will be discussed further below, the second battery 110 may be electrically connected with the motor 102 selectively to move the vehicle 100 at least a short distance or duration, e.g., upon detection of a thermal event of the first battery 108 while the vehicle 100 is in a parked position.

The battery modules 108, 110 may be connected with motor 102 and other electrical devices of the vehicle 100 in any manner that is convenient, e.g., by way of an electrical bus system of the vehicle having a positive bus rail 112 and a negative bus rail 114, as shown in FIGS. 1A-1C. Generally, the traction battery 108 may provide a high-voltage power supply to meet requirements for operating the motor(s) 102 to provide sufficient propulsion to the vehicle 100 and adequate range. In one example, the battery has an operating voltage of 400 Volts, although other operating voltages may be employed without limitation. The traction battery 108 may also supply electrical power at its operating voltage other high-voltage electrical modules 121 of the vehicle 100 by way of the bus rails 112, 114.

By contrast, the second battery 110 may be a secondary or relatively lower-voltage battery with a primary purpose of supplying power to various modules or devices of the vehicle 100 without the higher-voltage requirements of the motor 102. Merely by way of example, the secondary battery 110 may be a 12 Volt battery. The secondary battery 110 may generally provide power to controllers of the vehicle (e.g., the motor controller 106 as shown in FIG. 1A), accessories, or any other module or device of the vehicle with relatively lower voltage requirements than the motor(s) 102 or the high-voltage electrical modules 121.

The vehicle 100 may also include a battery management system (BMS) 116, which may also be powered by the second battery 110. The BMS 116 may include a controller or processor, and a memory in communication with the controller. The memory may include a computer-readable storage medium tangibly embodying instructions, which may cause the controller to implement various processes or steps thereof described further below. The BMS 116 may be a single controller, or various aspects of the BMS 116 may be distributed amongst other controllers of the vehicle 100, e.g., the motor controller 102, an autonomous driving controller, or the like. The BMS 116 is in communication with a converter 118, which is electrically connected to the positive bus rail 112 and the negative bus rail 114. In an example illustration, the converter 118 is a DC/DC converter that is configured to decrease a relatively high voltage received from the bus rails 112, 114, e.g., typical of the operating voltage of the battery module 108, and supply electrical power to the second battery 110 at a reduced voltage to charge the second battery 110. Additionally, the converter 118 may be a bidirectional DC/DC converter, i.e., such that the converter 118 may also selectively increase an applied voltage, e.g., received from the second battery 110. Accordingly, the converter 118 may include transformers, a buck-boost converter, or the like to facilitate selectively increasing or reducing an input voltage of the converter 118 in comparison to an output voltage of the converter 118. Moreover, as will be discussed further below, in some example illustrations the second battery 110 may be used in this manner to provide power to the motor(s) 102. More specifically, the relatively lower voltage of the secondary battery 110 may be increased sufficiently to drive the motor 102 for at least a short time or distance, thereby allowing the vehicle 100 to be moved some distance from adjacent property. Accordingly, the bidirectional converter 118 may be configured to modify an input voltage to the second battery 110 such that the second battery 110 operates at a voltage lower than the that of the traction battery 108. The bidirectional converter 118 may, for example, reduce voltage supplied to the second battery 110 (e.g., by the traction battery 108) to a voltage identical to a relatively lower operating voltage of the second battery 110, or substantially so. As will be discussed further below, the bidirectional converter 118 may at other times increase voltage supplied by the second battery 110 to a voltage identical to a relatively higher operating voltage (e.g., of motor(s) 102), or substantially so.

The bus rails 112, 114 may facilitate charging the traction battery 108, supplying power from the traction battery 108 to motor(s) 102, and modification of a voltage supplied from the traction battery 108, e.g., via electrical isolation of the traction battery 108, under certain conditions. Main contactor switches 120a, 120b (collectively, 120) may be used to electrically isolate battery cells 122 of the traction battery 108, as illustrated in FIG. 1A, and may be closed to connect the battery cells 122 to a load, e.g., the motor 102, via the bus rails 112, 114. It should be understood that the battery cells 122 may include any number of cells as may be convenient to provide a sufficient power reserve for the vehicle 100.

A precharge circuit 124 may also be provided to generally minimize current upon initial connection of a relatively high voltage to a circuit, e.g., to or from the battery cells 122. Merely by way of example, the precharge circuit 124 may include electrical components configured to reduce current initially and increase the current over time, e.g., a thermistor. In the example illustrated in FIG. 1A, the precharge circuit includes a resistor 126 and a precharge switch 128, which may be selectively opened/closed to effect reductions in current initially upon application of an electrical potential. The reduction in initial current may improve durability of electrical connections in the traction battery 108 and/or bus rails 112, 114, such as by reducing the possibility of an electrical arc that may otherwise cause pitting or other defects in electrical connections. To the extent the converter 118 is a bidirectional DC/DC converter, the precharge circuit 124 may not necessary, as the bidirectional DCDC converter 118 may be capable of implementing a relatively gradual buildup of current when initially applying a voltage to a circuit, particularly for elevated voltages characteristic of an operating voltage of the battery 108 and/or motor(s) 102.

The vehicle 100 may also have a charge port 124 for facilitating charging of the battery cells 122 of the traction battery 108 and/or the secondary battery 110. The charge port 124 may be configured to allow charging via a typical AC power supply or a DC power supply of a relatively higher voltage. To this end, charge contactor switches 130a, 130b may be provided in a charge port positive bus branch 132 and a charge port negative bus branch 134, respectively. The charge contactor switches 130a, 130b may be closed upon connection of a DC charger to charge port 124, allowing the battery cells 122 to be charged by way of the bus rails 112, 114. By comparison, if an AC power supply is connected to the charge port 124, AC power may be supplied to on-board charger 136. The on-board charger 136 may convert the AC power to DC power, which may be supplied to the bus rails 112, 114 for charging the traction battery 108.

The vehicle illustrated in FIGS. 1A-1C is shown with the connected components such as the on-board charger 136 and the converter 118 as separate parts from the battery module 108, and the charge contactors 130a, 130b as being disposed within an interior of the battery 108. However, any of these or other electrically connected components of the vehicle 100 may be contained within an enclosure of the battery 108, or provided external to the battery 108, as may be convenient.

The battery management system 116 may control electrical components such as the main contactors 120, precharge switch 128, charge contactor switches 130, etc. to effect supplying power from the batteries 108 and/or 110 to vehicle components and charging the batteries 108 and/or 110. To this end, the BMS 116 may generally receive inputs from temperature and/or pressure sensors within the traction battery 108, sensors indicating application of a charge voltage to the charge port 122, sensors indicating a charge level of the battery 108 and/or cells 122. Moreover, as will be discussed further below the vehicle 100 may be provided with cameras, sensor, or other imaging devices for detecting surroundings of the vehicle 100, as may be useful in determining whether/when the vehicle 100 may be autonomously moved.

In the example shown in FIG. 1A, the battery management system 116 has placed the traction battery 108 in an electrically isolated state, i.e., such that no electrical load or external power supply is in communication with the battery 108 or the cells 112 thereof. More specifically, the BMS 116 has opened the main contactors 120a, 120b, such that the cells 122 of the battery 108 are electrically isolated. This electrically isolated state may be enacted by the BMS 116, e.g., upon sufficient charging of the battery 108 when the vehicle is parked or otherwise not in use to prevent overcharging. Additionally, the electrically isolated state of the battery 108 and/or cells 122 may be enacted by the BMS 116 in response to detected thermal conditions or a thermal event, as will be discussed further below.

Turning now to FIG. 1B, the BMS 116 has closed the main contactors 120a, 120b, thereby electrically connecting the cells 122 of the battery 108 with the main bus rails 112, 114. Accordingly, the BMS 116 may allow the battery 108 to supply power to the bus rails 112, 114, and ultimately to the motor(s) 102. The BMS 116 may also close the main contactors 120 as shown in FIG. 1B when the vehicle is to be charged via an AC power source. More specifically, when the BMS 116 detects that an AC charger has been connected to the charge port 124, the BMS 116 may close the main contactors 120a, 120b and allow AC power to flow to the on-board charger 136. The on-board charger converts the input AC power to DC power that is supplied to the bus rails 112, 114. The battery 108 may thereby be charged via the bus rails 112, 114.

Turning now to FIG. 1C, the BMS 116 may close the charge contactor switches 130a, 130b, e.g., upon detection that a DC power supply, e.g., from a high-speed or high voltage charging station, has been connected to the charge port 124. The DC power may thereby be supplied to the bus rails 112, 114, allowing the battery 108 to be charged via the DC power.

In addition to facilitating power supply to/from the batteries 108 and/or 110, the battery management system 116 may facilitate monitoring the traction battery 108 for potential thermal events and may implement various responses. Upon parking of the vehicle 100, the vehicle 100 and/or the battery management system 116 may be placed in a “sleep” state. The BMS 116 may wake periodically to monitor thermal conditions of the battery 108, e.g., temperature and/or pressure, to determine whether a thermal condition is present in the battery 108. Any time period for waking from the sleep state to a monitoring state, i.e., where a thermal condition of the battery 108 is detected, may be employed that is convenient. Generally, a time period may be determined depending on a desired tradeoff between conserving battery power (i.e., with a longer sleep period) and a need to detect abnormal thermal conditions quickly (i.e., with a shorter sleep period). Merely as one example, a time period of 500 milliseconds to 1 second may be used, although variations from this range in view of the tradeoffs described above are possible.

Upon detection of an abnormal thermal condition, e.g., by way of pressure or temperature exceeding a threshold, an increase in a parameter of a predetermined magnitude within a predetermined time period, or change in gas content within the battery 108, the battery management system 116 may respond by modifying a supply voltage of the battery 108 or electrically isolating the battery 108, if the main contactors 120a, 120b are not already open (e.g., due to the BMS 108 detecting that the battery 108 is sufficiently charged and connected to an external power source). Accordingly, the battery cells 122 may be electrically isolated, e.g., as illustrated in FIG. 1A. With the traction battery 108 electrically isolated, the BMS 116 may continue to monitor the thermal conditions of the battery 108, e.g., temperature and/or pressure within the battery 108. If the BMS 116 determines that the thermal condition of the battery 108 is continuing to escalate, e.g., based upon a rapid increase in temperature and/or pressure, the BMS 116 may implement responses to alert a user of the thermal condition or move the vehicle 100. Merely as examples, the vehicle 100 may turn on a vehicle alarm, send a notification by automated phone call, short message system (SMS) text, or activate hazard lights or other visual cues.

With the traction battery 108 electrically isolated, the battery management system 116 may provide power to the motor(s) 102 from the secondary battery 110. More specifically, the converter 118 may receive an input voltage from the second battery 110 and convert the input voltage to a higher voltage. The higher voltage may be supplied to the bus rails 112, 114, and the motor(s) 102 may be driven to allow the vehicle 100 to be moved. Generally, a bidirectional DC/DC converter 118 may convert an input voltage received from the second battery 110, e.g., 12 V, to a higher voltage. The elevated voltage may be, but is not required to be, equal to the operating voltage of the traction battery 108 (e.g., 400 V). Rather, in one example the converter 118 generally may operate at a relatively high (or, in some cases, a maximum or highest) efficiency point at a voltage below the operating voltage of the battery 108 and/or motor 102, thereby generating sufficient power from the second battery 110 to move the vehicle 100. Generally, the needed voltage may be determined based upon at least the current needed to start the motor(s) 102. In one example illustration, 500-800 Amperes (A) may be needed to start the motor 102 and move vehicle 100. In another example illustration, 3-4 kilowatt-hours (kWh) may be required to move the vehicle 100 at relatively low speeds, with a slightly greater amount being required to start movement of the vehicle 100 from a stop. Additionally, it should be noted that the converter 118 may be placed in an electrically overloaded condition as a result of a significant step up in voltage, but this may be acceptable in the presence of a potential thermal runaway or emergency, and the relatively short period of operation under the overload. In one example, the motor 102 and/or vehicle 100 may only need to be moved a relatively short distance, e.g., 10 meters, or for a relatively short period of time, e.g., a few seconds, to adequately move the vehicle 100 from adjacent vehicles or property. Moreover, it may generally not be necessary to drive the motor(s) 102 at elevated power for purposes of moving the vehicle 100 over the expected short distance/time period. In one example illustration, a typical traction motor such as motor 102 may be capable of outputting 100 kilowatts (kW) of power or more, but to drive the vehicle 100 at low speed the motor may only need to output a fraction of that amount, e.g., 10 kW. Accordingly, an appropriate escalation of voltage of the second battery 110 by the converter 118 may be selected, e.g., by the battery management system 116, based upon any of the above factors.

The battery management system 116 may also consider various factors to determine whether or where to move the vehicle 100. In some examples, the BMS 116 may communicate with or otherwise cooperate with motor controller 102 or other vehicle control module or autonomous driving controller, e.g., with the BMS 116 providing a thermal event warning to a separate controller such as the motor controller 102, vehicle controller, or autonomous driving controller, with the separate controller determining whether the vehicle 100 may be autonomously moved. Merely as examples, the BMS 116 or other controller(s) of the vehicle 100 may consider the presence or absence of obstacles around the vehicle 100, a time of day at the time of the detected thermal condition (e.g., a home connected to a garage in which the vehicle 100 is located may be more likely to be occupied during evening hours), severity of the detected thermal condition, etc. In another example, the BMS 116 may consider the likelihood that moving the vehicle 100 may cause other damage if the vehicle 100 is connected to an external source of power via the charge port 124 during a thermal event. More specifically, the BMS 116 may consider whether moving the vehicle 100 would be likely to contact an offboard charging system, or to damage an external charger/power supply or cause an electrical exposure as a result of stress placed upon the charging device by the movement of the vehicle 100. A charging device inserted into the charge port 124 may, in some examples, be configured to facilitate withdrawal from the charge port 124 upon movement of the vehicle 100. For example, a magnetic connection of the charging device (not shown) may generally release upon movement of the vehicle 100. In other examples, a charging device or the charge port 124 may be configured to facilitate ejection or dislodging of a charging device from the charge port 124. In still another example, a physical disconnect device in an external charging device may be configured to separate upon application of a sufficient pulling force caused by the movement of the vehicle 100. Accordingly, the battery management system 116 may consider the presence or absence of the foregoing features in the charge port 124 and/or an external charging system in determining whether/where to effect movement of the vehicle 100.

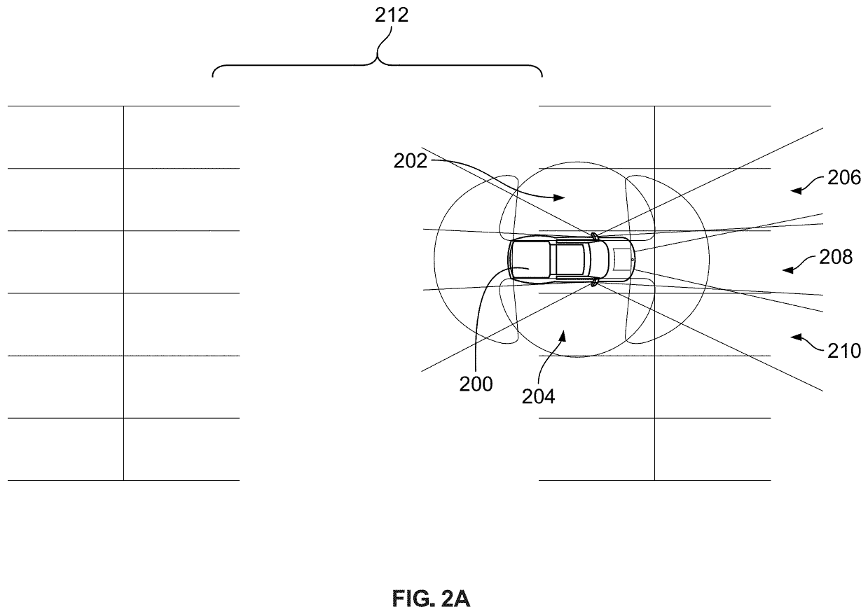

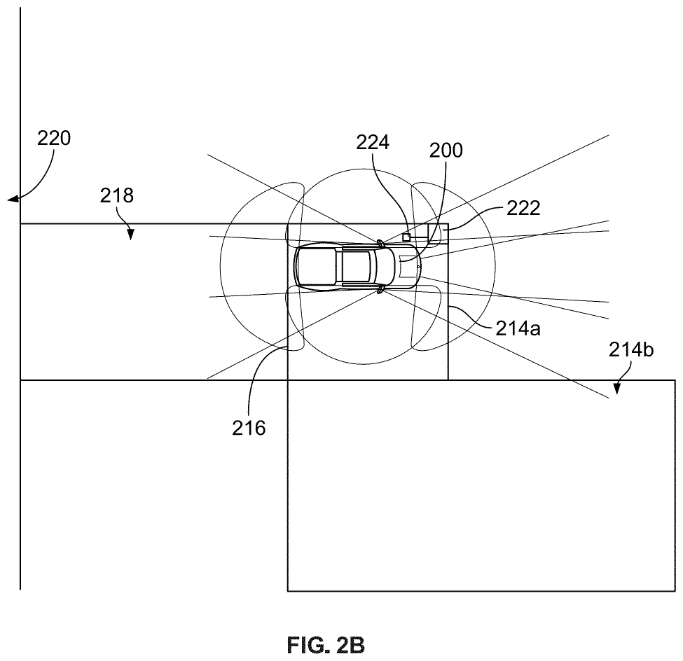

Turning now to FIG. 2A, an overhead view of an illustrative vehicle 200 is shown parked in a parking lot, in accordance with some embodiments of the present disclosure. The vehicle 200 may be vehicle 100, as an example. Upon detection of the vehicle 200 being parked in the lot, the vehicle 200 and/or battery management system 116 may monitor traction battery 108 for potential thermal abnormalities or events, e.g., by way of a battery management system 116 as described above. Upon determination that the vehicle 200 is under a thermal event, the vehicle 200 and/or the BMS 116 may analyze whether the vehicle 200 should be moved from a present/parked location. For example, the BMS 116 may consider the presence or absence of another vehicle in any of the nearby parking spaces 202, 204, 206, 208, or 210, e.g., by way of external sensors, cameras, or the like. Accordingly, if there are no nearby vehicles present in these parking spaces, the vehicle 200 may determine it is not necessary to move the vehicle 200, as the vehicle 200 is already a sufficient distance from other property. Alternatively, if the battery management system 116 determines, e.g., based upon camera or other imaging inputs, that one or more of the nearby parking spaces are occupied by another vehicle and a driving lane 212 through the parking lot is clear of other vehicle and pedestrian traffic, the BMS 116 may determine that the vehicle 200 should be moved from its current parked position. Accordingly, as discussed above the BMS 116 may connect the second battery 110 to the converter 118 to step up voltage of the second battery 110 sufficiently to power motor(s) 102 of the vehicle 200, and enact movement of the vehicle 200 away from the parked position and into the driving lane 212. In this manner, the vehicle 200 may be moved away from nearby vehicles or other property, thereby preventing or reducing damage to the same should the thermal condition of the vehicle 200 continue to escalate.

Referring now to FIG. 2B, another example parking location for the vehicle 200 is illustrated. In the example of FIG. 2B, the vehicle 200 is parked in an attached garage 214a adjacent a house 214b. The vehicle 200 may consider various factors to determine, upon detection of a thermal event of the vehicle 200 or traction battery thereof, whether the vehicle 200 should be moved from the parking location shown. Merely as examples, the battery management system 116 or other controller of the vehicle 200 may consider whether a garage door 216 is open (or may be opened by the vehicle 200, if the vehicle 200 is connected with the garage door 216 to do so), whether a driveway 218 extending from the garage 214a is occupied by another vehicle, and/or whether a street adjacent the driveway 218 is clear of vehicle and/or pedestrian traffic. Further, the vehicle 200 is illustrated being connected to an external charger 222, which is connected to the charge port 124 of the vehicle 200 with a charge connector 224. The BMS 116 or other controller of the vehicle 200 may thus also consider whether the charge connector 224 being inserted to the charge port 124 of the vehicle, or otherwise connected to the vehicle 200, may interfere with attempts to move the vehicle or cause comparatively greater damage than an ongoing thermal event of the vehicle 200. The BMS 116 may also consider whether a direction of movement of the vehicle 200 may be aligned with a withdrawal direction of a charging device, and/or whether the charge port 124 and/or charge connector 224 are configured to facilitate disconnection of the charge connector 224 from the vehicle 200.

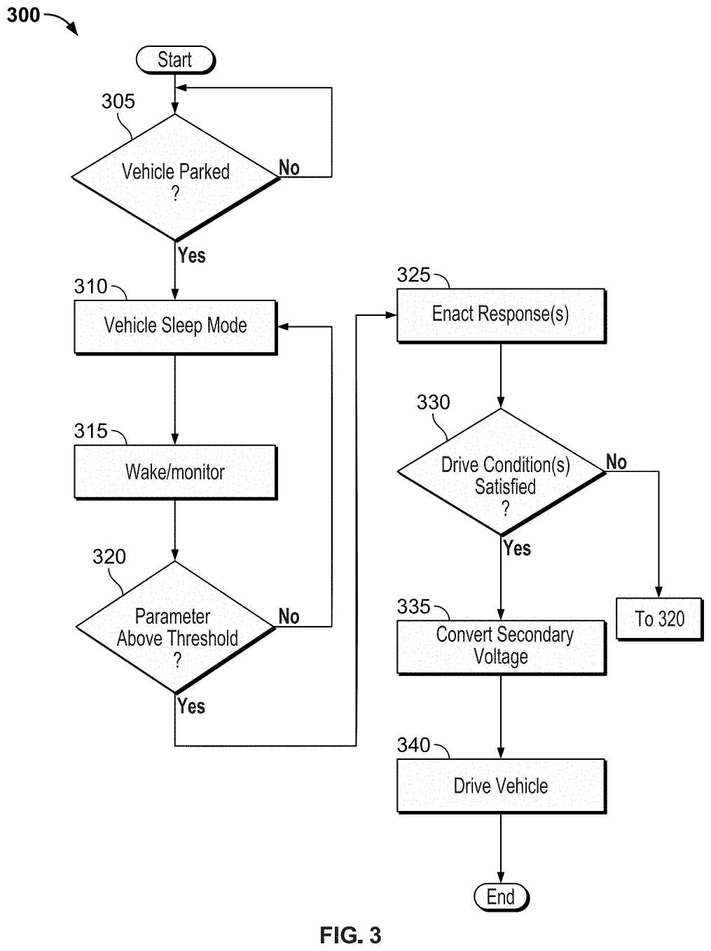

Turning now to FIG. 3, a flowchart of an illustrative process 300 for moving a vehicle from a parked position by supplying power from a secondary battery to a vehicle motor is illustrated. Process 300 may begin at block 305, where process 300 may determine whether a vehicle is parked, or otherwise unoccupied. Process 300 may use block 305 to prevent modification of voltage supplied by a battery module or electrical isolation of a battery module when the vehicle is occupied or in motion, in which case is may be relatively more desirable, even upon detection of a thermal event, to allow a driver of the vehicle to drive the vehicle as needed, e.g., off of a road or otherwise to a relatively safer location. The battery management system 116 may, for example, determine whether the vehicle is parked based upon inputs received from vehicle speed sensor(s) and/or occupant detection sensors, for example. Where process 300 determines that the vehicle is not parked or unoccupied, e.g., the vehicle is in motion, process 300 may proceed back to block 305. On the other hand, if process 300 determines that the vehicle is parked, process 300 may proceed to block 310.

At block 310, process 300 may enact a sleep mode of the vehicle, in which power consumption of the vehicle 100/200 is relatively minimized. The battery management system 116 may periodically wake from the sleep mode to analyze one or more parameters associated with a presence or absence of a thermal event. For example, upon expiration of a sleep timer at block 310, process 300 may proceed to block 315, where process 300 may wake the battery management system 116 to a monitoring mode. The sleep timer or sleep period may be any length of time that is convenient, such as 500 milliseconds to one second. In the monitoring mode, the battery management system 116 may receive or review one or more parameters relating to thermal condition(s) of the battery 108 and/or other components of the vehicle 100. Merely as examples, the battery management system 116 may analyze temperature and/or pressure within the battery 108, and/or changes in temperature and/or pressure over time.

Proceeding to block 320, process 300 may query whether a parameter, e.g., a thermal parameter, exceeds a predetermined magnitude or threshold. For example, as discussed above, battery management system 116 may monitor temperature, pressure, or both, and/or other parameters to determine whether a thermal event or condition of the vehicle has been established. In some examples, parameters are monitored over a period of time to determine whether an increase of a predetermined magnitude within a predetermined period of time has occurred, thereby indicating a presence of a thermal condition. Merely by way of example, parameters such as an internal pressure, a gas content, or a change in gas content (e.g., relative amounts of hydrogen (H₂), carbon dioxide (CO₂), etc.) within a battery pack or module may be employed as a threshold. In one example, pressure change and gas content change are monitored together, and as such a threshold indicative of a thermal event employed at block 320 can include multiple parameters. Temperature or cell voltage may also be employed as parameters for a threshold; however, both may be relatively slower in providing an indication of a thermal event than pressure or gas content parameters. Where process 300 determines that one or more thermal parameters are above a relevant threshold, process 300 may proceed to block 325. On the other hand, if no thermal parameters have exceeded a threshold, process 300 may proceed back to block 310, such that the sleep/wake/monitoring cycle may continue.

At block 325, in response to the detection of the thermal parameter exceeding the predetermined magnitude, one or more responses may be enacted at the vehicle, e.g., by the battery management system 116. The battery management system 116 may modify a supply voltage of the first battery module or, in some cases, may electrically isolate the first battery module, e.g., traction battery 108, for example by opening the main contactors 120a, 120b. Other responses may also be implemented by the battery management system 116. Merely as examples, the BMS 116 may send notifications or activate audible or visible alarms of the vehicle, e.g., flashing vehicle lights or sounding the vehicle horn, transmit an alert via SMS text messaging, call emergency personnel or 911, etc. Process 300 may then proceed to block 330.

At block 330, process 300 may query whether condition(s) have been satisfied to move or drive the vehicle as a response to an ongoing thermal event or condition of the vehicle. Merely as examples, as discussed above the vehicle may employ sensors or imaging devices to determine whether the vehicle is within a garage or near other vehicles in the present parked location of the vehicle, and if so whether a path is clear for the vehicle from the parked location. The battery management system 116 may also determine whether the converter 118 and/or second battery 110 are capable of providing sufficient power to drive motor(s) 102. In one example, battery management system 116 may determine whether a state of charge of the second battery 110 is sufficient to supply power to drive the motor(s) 102 based upon the capabilities of the converter 118. Where process 300 determines that drive conditions have been satisfied, a path for the vehicle may also be determined by the battery management system 116, and process 300 may proceed to block 335.

Alternatively, process 300 may determine that drive condition(s) have not been satisfied. For example, battery management system 116 may determine that the vehicle is parked in a location that is not near any other vehicle or property, e.g., in an open parking lot. As another example, the battery management system 116 may determine that a connected charging device is unlikely to withdraw from the vehicle without causing damage to the vehicle and/or the charger. In still another example, process 300 may determine that a severity of the detected thermal event, though significant enough to warrant electrical isolation of the battery 108, does not exceed additional elevated thresholds indicative of a thermal runaway event. Where process 300 determines at block 330 that the drive condition(s) have not been satisfied, process 300 may proceed back to block 320, where parameters being monitored are compared with relevant threshold(s) as noted above.

At block 335, upon satisfaction of drive condition(s) at block 330, the battery management system 116 may convert a voltage of a secondary battery, which may be relatively lower than an operating voltage of the battery 108 and/or the motor(s) 102, to a higher voltage. For example, a bidirectional DC/DC converter may be employed to increase voltage of power received from the second battery 110. As noted above, the voltage may be increased above the operating voltage of the second battery 110. In some cases the voltage may be increased to be approximately equal to an operating voltage of the first battery 108 and/or motor(s) 102, while in other examples voltage need not be increased as high as the operating voltage of the first battery 108 and/or motor(s) 102, depending on a desired distance or duration of movement, capability of the converter 118, and requirements for starting and moving motor(s) 102. Process 300 may then proceed to block 340.

At block 340, the electric motor may be driven, thereby providing motive force to move the vehicle. Process 300 may then terminate.

The various example systems and methods herein may advantageously provide for modifying a supply voltage or electrical isolation of a potentially dangerous or damaging thermal event in a traction battery, while also permitting mobility of the vehicle at least for a short range or short duration. Moreover, the example illustrations herein may also facilitate alerts in response to detected thermal conditions or events, thereby allowing intervention by emergency personnel or a vehicle operator.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. A battery management system for an electric motor, the system comprising:
a controller in communication with a first battery module comprising a first operating voltage configured to drive the electric motor, the controller in communication with a second battery module comprising a second operating voltage lower than the first operating voltage; and
a bidirectional converter configured to modify a first input voltage to the second battery module such that the second battery module operates at the second operating voltage lower than the first operating voltage.

2. The battery management system of claim 1,
wherein the bidirectional converter is further configured to modify a second input voltage supplied by the second battery module, the second input voltage greater than the second operating voltage;
wherein the controller is configured to detect a thermal parameter exceeding a predetermined magnitude while a vehicle comprising the battery management system is stopped, and in response to the detection of the thermal parameter exceeding the predetermined magnitude, modify a supply voltage received from the first battery module; and
wherein the controller is configured to drive the electric motor using electrical power supplied by the second battery module after modifying the supply voltage of the first battery module, thereby causing the vehicle to move.

3. The battery management system of claim 2, wherein modifying the supply voltage of the first battery module comprises electrically isolating the first battery module.

4. The system of claim 1, wherein the elevated voltage is less than or equal to the first operating voltage of the first battery module.

5. The system of claim 1, wherein the controller is configured to determine, based upon one or more sensor inputs, that an operator is not present in the vehicle, wherein the controller is configured to electrically isolate the first battery module in response to determining the operator is not present in the vehicle.

6. The system of claim 1, wherein the controller is configured to determine, based upon one or more sensor inputs, that the vehicle is parked, wherein the controller is configured to electrically isolate the first battery module in response to determining the operator is not present in the vehicle.

7. The system of claim 1, wherein the controller is configured to determine, based upon one or more sensor inputs and prior to driving the electric motor, a clear path for the vehicle from a current parked location of the vehicle.

8. The system of claim 1, wherein the thermal parameter is an internal pressure of the first battery module.

9. The system of claim 1, wherein the controller is configured to determine the thermal parameter exceeds a predetermined magnitude by detecting an increase in the thermal parameter over time.

10. A propulsion system for a vehicle, comprising:
an electric motor;
a first battery module comprising a first operating voltage configured to drive the electric motor; and
a battery management system for the electric motor, comprising:
a controller in communication with the first battery module, the controller in communication with a second battery module comprising a second operating voltage lower than the first operating voltage; and
a bidirectional converter configured to modify a first input voltage to the second battery module such that the second battery module operates at the second operating voltage lower than the first operating voltage.

11. A method of moving a parked vehicle having an electric motor configured to drive at least one ground-engaging wheel, the method comprising:
detecting, in a first battery module having a first operating voltage, a thermal parameter exceeding a predetermined magnitude, the first battery module configured to drive the electric motor to provide motive force to the vehicle;
in response to the detection of the thermal parameter exceeding the predetermined magnitude, modifying a supply voltage of the first battery module; and
after modifying the supply voltage of the first battery module, driving the electric motor using a second battery module having a second operating voltage lower than the first operating voltage, thereby moving the vehicle.

12. The method of claim 11, wherein modifying the supply voltage of the first battery module includes electrically isolating the first battery module.

13. The method of claim 11, wherein powering the electric motor using the secondary battery includes supplying electrical power from the second battery module via a converter.

14. The method of claim 13, wherein the converter is a bidirectional converter configured to operate in a first mode to electrically charge the second battery module by decreasing a first input voltage to the second operating voltage, and supplying power to the second battery module at the second operating voltage; and
wherein the converter is configured to operate in a second mode to supply electrical power to drive the electric motor by increasing a second input voltage received from the second battery module to an elevated voltage, the elevated voltage greater than the second operating voltage of the second battery module.

15. The method of claim 14, wherein the elevated voltage is less than or equal to the first operating voltage of the first battery module.

16. The method of claim 11, further comprising determining an operator is not present in the vehicle, wherein the first battery module is electrically isolated in response to determining the operator is not present in the vehicle.

17. The method of claim 11, further comprising determining the vehicle is parked, wherein the first battery module is electrically isolated in response to determining the operator is not present in the vehicle.

18. The method of claim 11, further comprising determining, prior to driving the electric motor, a clear path for the vehicle from a current parked location of the vehicle.

19. The method of claim 11, wherein the predetermined magnitude of the thermal parameter indicates a thermal runaway of the first battery module.

20. The method of claim 11, wherein the thermal parameter is an internal pressure of the first battery module, and wherein detecting the thermal parameter exceeding a predetermined magnitude includes detecting an increase in the thermal parameter over time.
